(19) United States
(12) Patent Application Publication
(10) Pub. No.: US 2011/0029330 A1
(43) Pub. Date: Feb. 3, 2011

(54) AUTOMATED INSURANCE APPOINTMENT PROCESSING SYSTEM

(76) Inventors: John Francis Paddock, III, Simsbury, CT (US); Wesley Forrest Sprinkle, Canton, CT (US); Celeste M. Neilsen, Bristol, CT (US); Wendell Bruce Lund, III, Colchester, CT (US); Sandra J. Meyerhofer, Rocky Hill, CT (US)

Correspondence Address: BUCKLEY, MASCHOFF & TALWALKAR LLC, 50 LOCUST AVENUE, NEW CANAAN, CT, 06840, US

(21) Appl. No.: 12/534,419

(22) Filed: Aug. 3, 2009

(51) Int. Cl. G06Q 40/00

(52) U.S. Cl. 705/4

(57) ABSTRACT

According to some embodiments, a plurality of new work notifications are received, each associated with a producer identifier. A set of non-appointed new work notifications may be determined, including a first non-appointed new work notification and a second non-appointed new work notification, the second non-appointed new work notification being received after the first non-appointed new work notification, and at least some of the non-appointed new work notifications may be automatically prioritized such that the second new work notification is assigned a higher priority as compared to the first new work notification. It may then be arranged for a manual appointment processing procedure to be performed for at least some of the non-appointed new work notifications in accordance with the prioritizing.

### BACKGROUND

In most cases, a person or entity may need to be registered with and/or licensed by a governmental agency. For example, a person or entity who sells, solicits, or negotiates certain types of insurance policies might need to be licensed by a state department of insurance. Although state departments of insurance are used in connection with some examples provided herein, note that in some cases other governmental authorities may be involved. The state department of insurance may, for example, maintain records about the person or entity to help protect the public in exchange for payment of an initial and/or annual fees. Moreover, an insurance company may “appoint” the person or entity to authorize them to sell, solicit, or negotiate insurance on behalf of the insurance company. The insurance company may also need to file an indication of all such appointments with the state department of insurance (or other appropriate governmental authority) along with an appropriate licensing fee (including new licensing fees and renewal fees as defined by the governmental authority).

An insurance company might appoint all persons and entities who might potentially sell, solicit, or negotiate insurance on behalf of the insurance company with the appropriate state departments of insurance. Such an approach, however, could be prohibitively costly because many of the potential persons and entities might turn out to not actually sell, solicit, or negotiate any insurance in a given year or be limited to one writing company as opposed to all writing companies that might be utilized by a carrier in a particular state.

As another approach, and where permitted by law, an insurance company might wait until a person or agency has actually sold, solicited, or negotiated insurance on behalf of the insurance company before arranging and filing the appropriate appointments. Note that most states allow a person or entity to be appointed within a “grace period” after the sale of an insurance policy (e.g., within five days of the sale of a policy in that state). This approach, sometimes referred to as “just in time” appointments, can be a time consuming manual task, especially when thousands of new insurance policies in many different states could be sold in a single day. Another disadvantage of manually managing just in time appointments is that it can be an error prone process. Note that an insurance company might be required to pay a fine or other penalty when insurance policies are inadvertently sold without the proper appointments submitted to the state in accordance with state processing guidelines.

### BRIEF DESCRIPTION OF THE DRAWINGS

FIG. 1 illustrates relationships between some of the parties associated with embodiments of the present invention.

FIG. 2 is block diagram of a system to facilitate insurance appointment processing in accordance with some embodiments.

FIG. 3 illustrates a method according to some embodiments of the present invention.

FIG. 4 is a high-level illustration of elements of an insurance appointment processing system in accordance with some embodiments.

FIG. 5 is a more detailed block diagram of a system to facilitate insurance appointment processing according to some embodiments of the present invention.

FIG. 6 is flow diagram of insurance appointment processing according to some embodiments of the present invention.

FIG. 7 is an example of a new work notification input display according to some embodiments.

FIG. 8 is a block diagram of an insurance appointment processing apparatus in accordance with some embodiments of the present invention.

FIG. 9 is a tabular view of a portion of a new work notification database in accordance with some embodiments of the present invention.

FIG. 10 is an example of a display according to some embodiments.

### SUMMARY OF THE INVENTION

According to some embodiments, a plurality of new work notifications are received, each associated with a producer identifier. A set of non-appointed new work notifications may be determined, including a first non-appointed new work notification and a second non-appointed new work notification, the second non-appointed new work notification being received after the first non-appointed new work notification, and at least some of the non-appointed new work notifications may be automatically prioritized such that the second new work notification is assigned a higher priority as compared to the first new work notification. It may then be arranged for a manual appointment processing procedure to be performed for at least some of the non-appointed new work notifications in accordance with said prioritizing.

Other embodiments include: means for receiving a plurality of new work notifications, each associated with a producer identifier; means for determining a set of non-appointed new work notifications, including a first non-appointed new work notification and a second non-appointed new work notification, the second non-appointed new work notification being received after the first non-appointed new work notification; means for automatically prioritizing at least some of the non-appointed new work notifications such that the second new work notification is assigned a higher priority as compared to the first new work notification; and means for arranging for a manual appointment processing procedure to be performed for at least some of the non-appointed new work notifications in accordance with said prioritizing.

In some embodiments, a communication device associated with automated insurance appointment processing receives information from and/or transmits information to remote devices. The information may be exchanged, for example, via public and/or proprietary communication networks.

A technical effect of some embodiments of the invention is an improved and automated insurance appointment processing system for insurance companies, producers, and agencies. With this and other advantages and features that will become hereinafter apparent, a more complete understanding of the nature of the invention can be obtained by referring to the following detailed description and to the drawings appended hereto.

### DETAILED DESCRIPTION

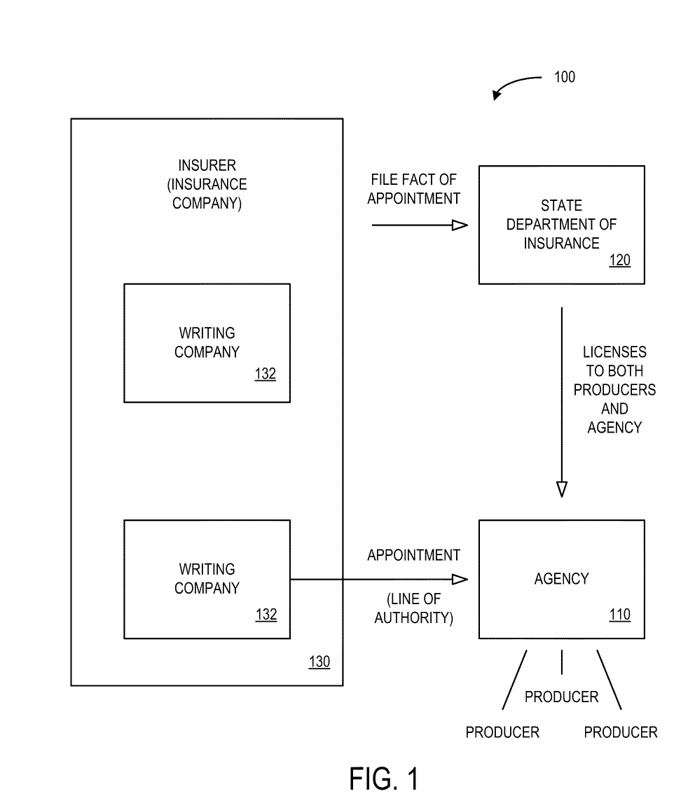

A person or entity may need to be registered with and/or licensed by a governmental agency in connection with the sale of insurance products. For example, FIG. 1 illustrates relationships between some of the parties associated with embodiments of the present invention. As shown, one or more “producers” and an agency 110 may receive a license from a state department of insurance 120 in exchange for payment of an initial and/or annual fees. Moreover, an insurance company 130 may have writing companies 132 that “appoint” the producers and agency 110 to authorize them to sell, solicit, or negotiate insurance on behalf of the insurance company. Note that an appointment may be limited to a particular line of authority (e.g., a particular type of insurance product). The insurance company 130 may also need to file an indication of all such appointments with the state department of insurance 120 (or other appropriate governmental authority) along with an appropriate fee.

The insurance company 130 might appoint all producers who might potentially sell, solicit, or negotiate insurance on behalf of the insurance company with the appropriate state departments of insurance 120. Such an approach, however, could be prohibitively costly because many of the potential producers might turn out to not actually sell, solicit or negotiate any insurance on behalf of the insurance company in a given year. This may result in significant expenses for an insurance carrier. As another approach, and where permitted by law, the insurance company 130 might wait until a producer has actually sold, solicited, or negotiated insurance on behalf of the insurance company before arranging and filing the appropriate appointments. Note that most states allow a producer to be appointed within a “grace period” after the sale of an insurance policy (e.g., within five days of the sale of a policy in that state). This approach, sometimes referred to as “just in time” appointments, can be a time consuming manual task, especially when thousands of new insurance policies in many different states could be sold in a single day. Another disadvantage of manually managing just in time appointments is that it can be an error prone process. For example, many errors may be attributed to failing to submit appointments in accordance with state guidelines. Note that the insurance company 130 might be required to pay a fine or other penalty when insurance policies are inadvertently sold without the proper appointments.

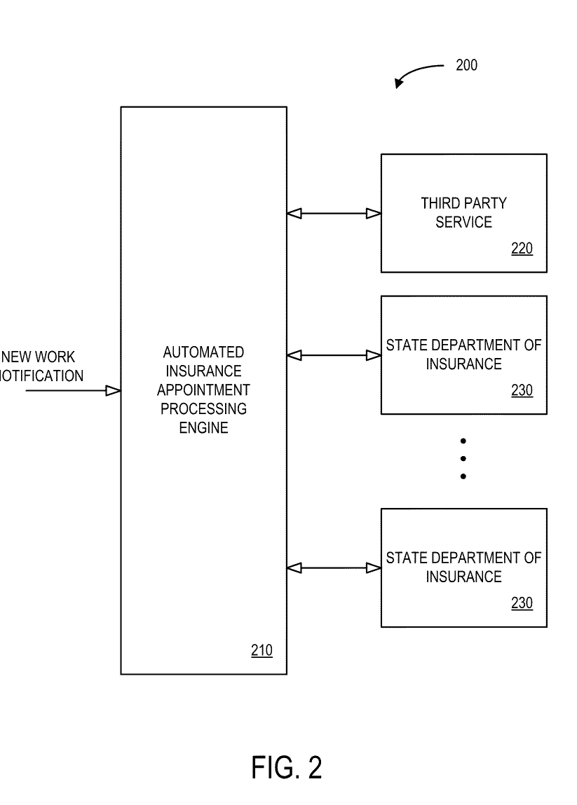

To help reduce such problems, FIG. 2 is block diagram of a system 200 to facilitate the automated management of insurance appointments in accordance with some embodiments of the present invention. In particular, an automated insurance appointment processing engine 210 may receive new work notifications. The new work notifications might be received, for example, via a manual web page request or an online based new business submission system when a producer has recently sold a new insurance policy.

The automated insurance appointment processing engine 210 may also exchange information with a number of state departments of insurance devices 230 and/or a third party service 220 (e.g. a third party service 220 that handles appointment filings for many different states). The state department of insurance devices 230 might be associated with, for example, web servers maintained by different insurance agencies in various states.

The automated insurance appointment processing engine 210 may facilitate an automated management of insurance appointments in various states in accordance with any of the embodiments described herein. As used herein the term “automated” indicates that at least some part of a step associated with a process or service is performed with little or no human intervention. By way of examples only, the automated insurance appointment processing engine 210 might be associated and/or communicate with a Personal Computer (PC), an enterprise server, and/or a database farm.

Any of the devices described in connection with the system 200 may access information in one or more databases. The databases may include, for example, information about new work notifications and/or insurance appointment rules associated with various jurisdictions. Moreover, any of the devices may exchange information via a communication network. These devices (and any of the other devices described herein) could be associated with, for example, a server, a PC, a mobile or laptop computer, or any other appropriate storage and/or communication device to exchange information via a web site and/or a communication network. As used herein, devices (including those associated with the automated insurance appointment processing engine 210 and any other device described herein) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The devices of FIG. 2 might, according to some embodiments, be accessible via a Graphical User Interface (GUI). The GUI might be used, for example, to dynamically display existing appointment information, to receive new work indications, and to input or output information about rules governing appointments, and/or to generate or display reports about appointments.

Although a single automated insurance appointment processing engine 210 is shown in FIG. 2, any number of such devices may be included. Moreover, various devices described herein might be combined or co-located according to embodiments of the present invention.

The automated insurance appointment processing engine 210 might include, for example, a communication device to receive information from a plurality of remote input devices. The input devices might be associated with, for example, a person or entity selling insurance, a scanning service, or a fax machine.

The automated insurance appointment processing engine 210 might further include a processor coupled to the communication device and a storage device in communication with the processor and storing instructions adapted to be executed by said processor to facilitate the automated management of insurance appointments in accordance with any of the embodiments described herein.

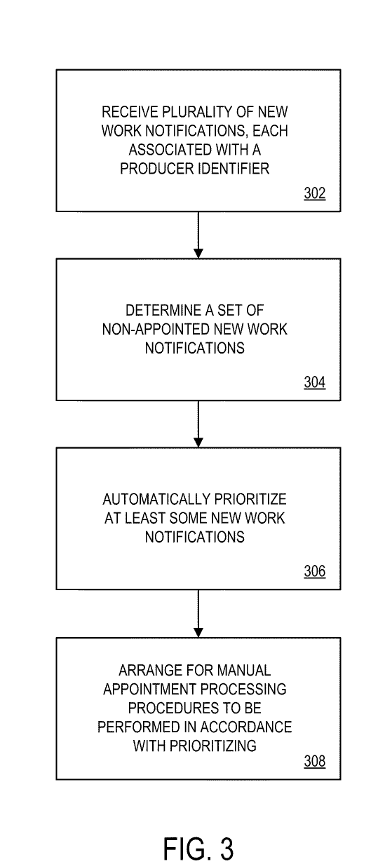

FIG. 3 illustrates a method that might be performed, for example, by some or all of the elements of the system 200 described with respect to FIG. 2 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 302, a plurality of new work notifications may be received, each associated with a producer identifier. The producer identifier may, for example, identify the person or entity that recently sold an insurance product. By way of example only, the producer identifier might be a name or a National Producer Number (NPN) associated with the person or entity. The new work notification may further include information about the type of insurance policy being sold and the jurisdiction associated with the policy (e.g., based on a state identifier). According to some embodiments, the new work notifications are associated with property and casualty insurance policies.

At 304, a set of non-appointed new work notifications are determined. For example, it may be determined that some of the new work notifications are associated with a producer who is already licensed and appointed in the appropriate state (e.g., the new work notification is already “compliant” and no further steps are need with respect to appointments). In other cases, however, it may be determined that the person or entity associated with the new work notification is licensed but not yet appointed in the appropriate jurisdiction (e.g., he or she has never been appointed in that state or a previous appointment has lapsed). Note that a determination of a non-appointed (and thus not yet compliant) new work notification may result from either a non-appointed producer or a non-appointed agency associated with the producer. In the case of a producer that is properly licensed but not yet appointed, an automated process and/or third party service may simply automatically arrange for a just in time appointment.

According to some embodiments, the system may also identify at least one non-appointed new work notification as satisfying a pre-determined condition. For example, the system might note that a particular type of insurance policy was sold by an unlicensed producer or is a type of insurance policy that has additional requirements that may need to be satisfied (e.g. a background check might need to be perform with respect to the producer selling the policy). For these cases, the system might, in response to the identification, generate an exception handling event (e.g., indicating that the work notification requires a manual review).

At 306, the system may automatically prioritize at least some of the non-appointed new work notifications associated with exception handling events. Note that different states may have different “grace periods” (e.g., compliance time requirements) associated with appointments. For example, a first state might allow a person to be appointed within three days of a sale of an insurance policy while a second state allows appointment within 45 days of a sale. In this case, non-appointed new work notifications associated with the first state may be assigned a higher priority as compared to notifications associated with the second state (e.g., so that those appointment will be processed first). That is, a first new work notification might be assigned a higher priority as compared to a second new work notification—even when the second new work notification was received before the first new work notification. Such an approach may let an insurance company maintain the proper appointments without requiring an impractical amount of resources.

At 308, it may be arranged for a manual appointment processing procedure to be performed for at least some of the non-appointed new work notifications in accordance with said prioritizing. For example, an automated insurance appointment processing engine 210 may generate a list to be given to employees of an insurance company to arrange for the appropriate appointments.

According to some embodiments, the system may store information about new work notification and/or appointments and use the stored information to generate reports. For example, a report associated with a batch of new work notifications might be used to review the performance of the system, to determine cost savings, and/or to demonstrate to regulators that proper steps are being taken to ensure that appointments are being managed in an appropriate way.

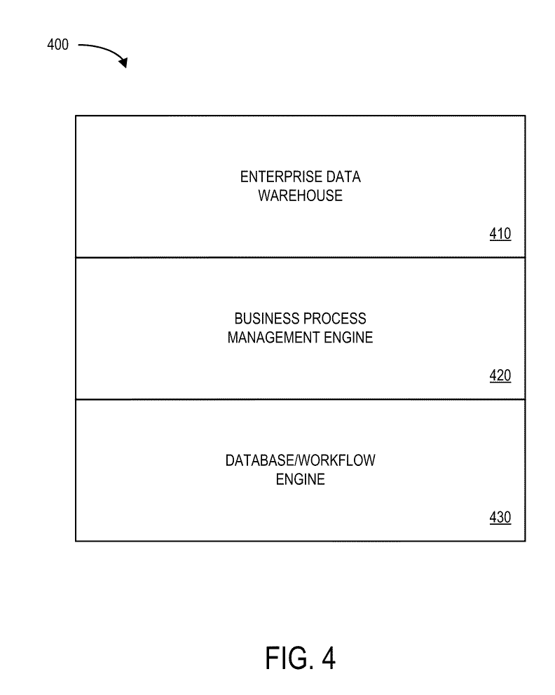

FIG. 4 is a high-level illustration of elements of an insurance appointment processing system 400 in accordance with some embodiments. In particular, the system 400 includes an enterprise data warehouse 410 that may provide information management functions in connection with insurance appointment processing. The system 400 further includes a business process management engine 420 that may, for example, be rules driven and support business process management functions. For example, the business process management engine 420 might support business activity monitoring on appointments (both automated and manual). According to some embodiments, the business process management engine 420 also facilitates a workflow process for manual exception processing.

The system 400 also includes a database/workflow engine 430 that may, for example, capture and store appointment information and/or transmit out appointment request to state insurance agency devices (e.g. along with payment information).

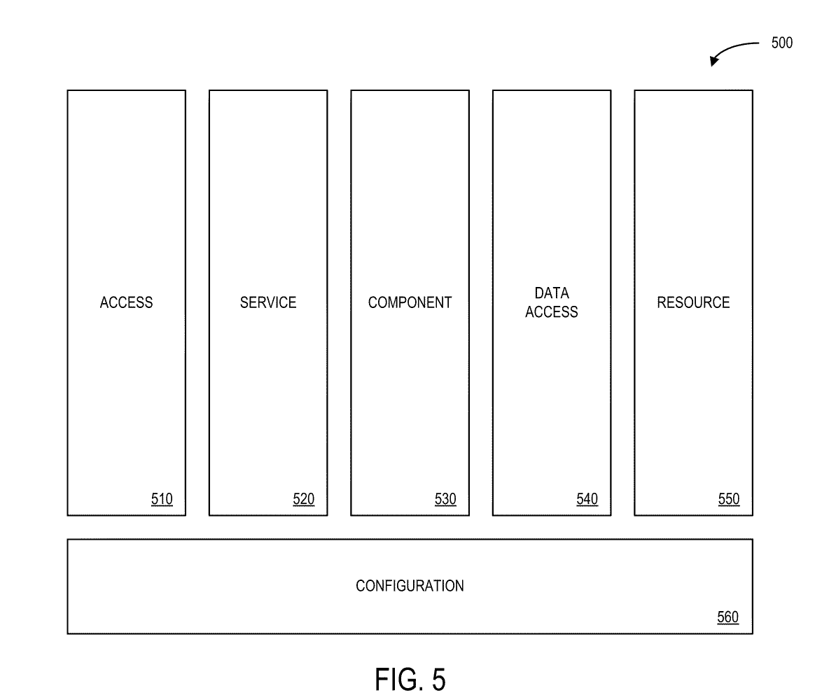

FIG. 5 is a more detailed block diagram of a conceptual architecture 500 to facilitate insurance appointment processing according to some embodiments of the present invention. The architecture 500 includes an access element 510 that may, for example, support web form for work items associated with insurance appointments and/or support interfaces with business process management and database/workflow solutions. The architecture 500 also includes a service element 520 that might, for example, support an agent/producer list serve (e.g., a list of all producer/agent NPNs and names associated with the legal entity for a given agency code) and/or a back-end batch validation process. A component element 530 may be provided to support an agent/producer master file and a data access element 540 may be used to update a book of business and/or to provide an interface with an enterprise data warehouse. A resource element 550 may handle policy submissions and valid, for example, a NPN for each policy transaction. A configuration element 560 may support, for example, foundation services, web logic, and/or enterprise data warehouse configurations.

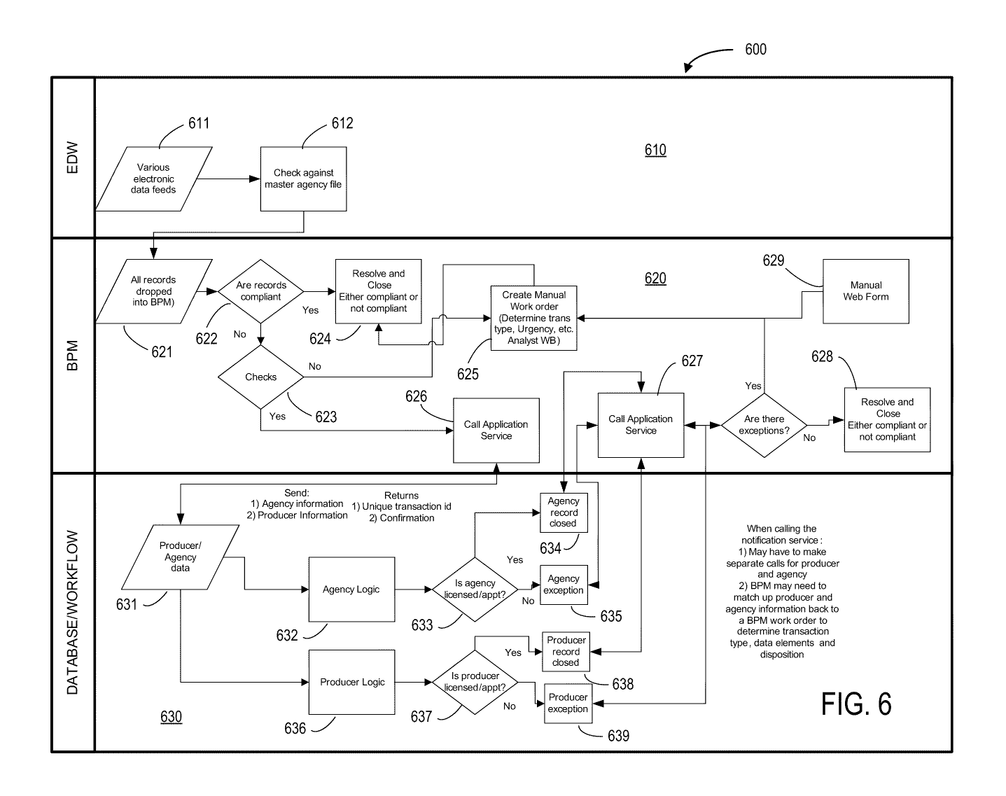

FIG. 6 is flow diagram of insurance appointment processing 600 (e.g., a business model view) according to some embodiments of the present invention. In this case, enterprise data warehouse logic 610 receives various electronic data feeds 611 (e.g., from various producers via the Internet) and checks new work notifications against a master agency file 612. The checks 612 may be used to enrich and/or clean the data received from the producers.

The records are then dropped 621 to business process management logic 620 which identifies records that are not yet compliant 622 (e.g., for the lack of an appropriate appointment or license). Note that already compliant records may simply be resolved and closed 624 (no further work needs to be done for those records). The business process management logic 620 may also perform checks 623. The checks 623 might indicate, for example, whether or not a state allows agency endorsements or whether an executed background consent is current on file with the insurer. The checks 623 determine whether an application service will be called 626 or whether an exception needs to be generated 625 (e.g., because some required paperwork is not in the file). The business process management logic 620 may also prioritize the records at 625 (e.g. based on associated state grace periods). The manual work may then be performed by employees of the insurer via a web form 629. The manual work may also result in exceptions that result in the close of a record as compliant or non-appointed 628 or a call to an application service 627.

The processing 600 further includes database/workflow logic 630 that arranges to obtain the agency or producer appointments as appropriate. In particular, the database/workflow logic 630 receives producer/agency data 631 from the a third party service and executes agency logic 632 to determine if the agency is properly licensed and appointed 633. Based on the determination, the agency record may be closed 634 or an agency exception 635 may be returned to the business process management logic 620. Similarly, the database/workflow logic 630 may execute producer logic 636 to determine if the producer is properly licensed and appointed 637. Based on this determination, the producer record may be closed 638 or an producer exception 639 may be returned to the business process management logic 620.

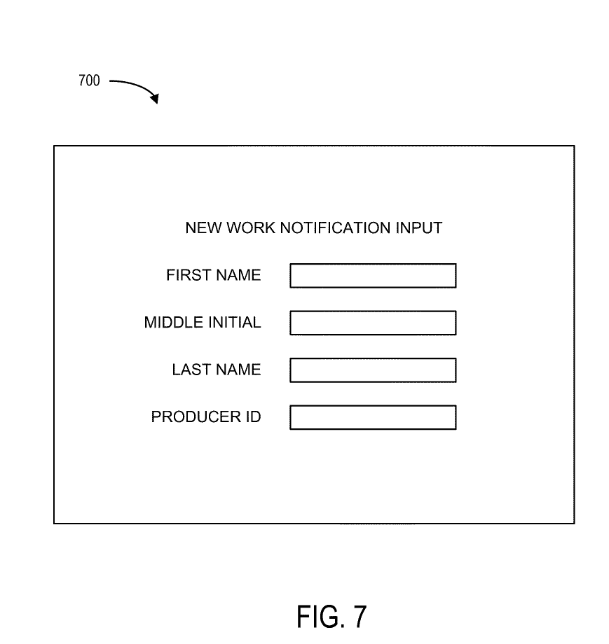

FIG. 7 is an example of a new work notification input display 700 according to some embodiments. The display 700 might be used, for example, by a producer who recently sold an insurance product. The display 700 might be used, for example, to enter a name and/or producer identifier associated with the new work notification. According to some embodiments, the producer identifier must be selected from a list of potential producer identifiers (e.g. to ensure that the producer is already in the system). Note that an actual display would include additional information, such as a policy type, an address or state code, and/or a name of an insured party.

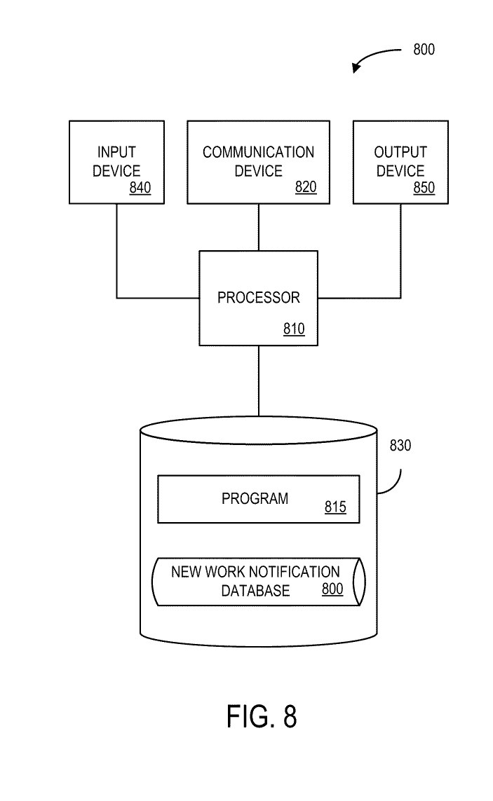

FIG. 8 is a block diagram of an automated insurance appointment apparatus 800 in accordance with some embodiments of the present invention. The apparatus 800 might, for example, comprise a platform or engine similar to the automated insurance appointment processing engine 110 illustrated in FIG. 1. The apparatus 800 comprises a processor 810, such as one or more INTEL® Pentium® processors, coupled to a communication device 820 configured to communicate via a communication network (not shown in FIG. 8). The communication device 820 may be used to exchange insurance policy information, for example, with one or more remote devices.

The processor 810 is also in communication with an input device 840. The input device 840 may comprise, for example, a keyboard, a mouse, or computer media reader. Such an input device 840 may be used, for example, to enter information about appointment rules and/or producers. The processor 810 is also in communication with an output device 850. The output device 850 may comprise, for example, a display screen or printer. Such an output device 850 may be used, for example, to provide reports and/or display information associated with appointment rules and/or producers.

The processor 810 is also in communication with a storage device 830. The storage device 830 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 830 stores a program 815 for controlling the processor 810. The processor 810 performs instructions of the program 815, and thereby operates in accordance with any embodiments of the present invention described herein. For example, the processor 810 may receive a plurality of new work notifications, each associated with a producer identifier. A set of non-appointed new work notifications may be determined by the processor 810, including a first non-appointed new work notification and a second non-appointed new work notification, the second non-appointed new work notification being received after the first non-appointed new work notification, and at least some of the non-appointed new work notifications may be automatically prioritized such that the second new work notification is assigned a higher priority as compared to the first new work notification. The processor 810 may then arrange for a manual appointment processing procedure to be performed for at least some of the non-appointed new work notifications in accordance with said prioritizing.

As used herein, information may be “received” by or “transmitted” to, for example: (i) the insurance apparatus 800 from other devices; or (ii) a software application or module within the insurance apparatus 800 from another software application, module, or any other source.

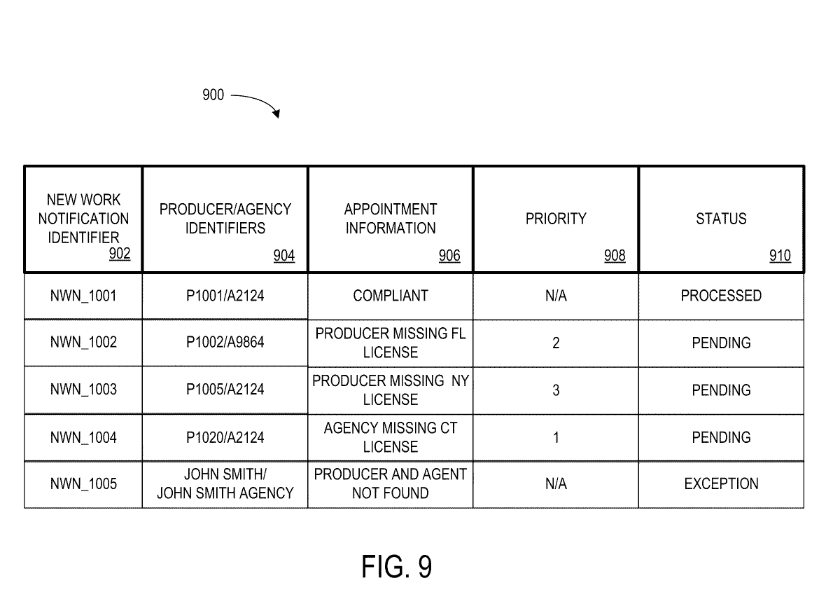

As shown in FIG. 8, the storage device 830 also stores a new work notification database 900. One example of such a database 900 that may be used in connection with the insurance apparatus 800 will now be described in detail with respect to FIG. 9. The illustration and accompanying descriptions of the database presented herein are exemplary, and any number of other database arrangements could be employed besides those suggested by the figures. For example, different databases associated with different types of policies or appointments might be associated with the apparatus 800.

FIG. 9 is a tabular view of a portion of the new work notification database 900 in accordance with some embodiments of the present invention. The table includes entries associated with new insurance policies that have been sold by producers. The table also defines fields 902, 904, 906, 908, 910 for each of the entries. The fields specify: a new work notification identifier 902, producer/agency identifiers 904, appointment information 906, a priority 908, and a status 910. The information in the database 900 may be periodically created and updated based on information received by a writing company and/or insurer from producers and/or third party service devices.

The new work notification identifier 902 might be, for example, an alphanumeric code that uniquely identifies a newly sold insurance policy, and the producer/agency identifiers 904 may be alphanumeric codes that uniquely identify the producer and agency that sold the policy (e.g., an ID number or name). The appointment information 906 might indicate, for example, that the new work notification is already compliant (e.g., the producer was already registered in the appropriate states). The appointment information 906 might instead, however, indicate that the new work notification is not yet appointed (e.g., the producer needs to be appointed or licensed in FL).

The priority 908 indicates when the required appointments should be obtained as compared to appointments for other new work notifications. For example, appointments that will require a manual process in states with relatively short grace periods may receive a higher priority as compared to those in states with longer grace periods (and, as a result, the high priority appointments will be processed first to ensure timely compliance with the state requirements). The status 910 may indicate whether the new work notification has already been “processed” or that appointments are still “pending.” According to some embodiments, the status 910 may indicate that the new work notification resulted in an “exception” (e.g. perhaps the insurer was unable to satisfy the conditions that would result in a compliant producer and further manual handling of the appointment situation is required).

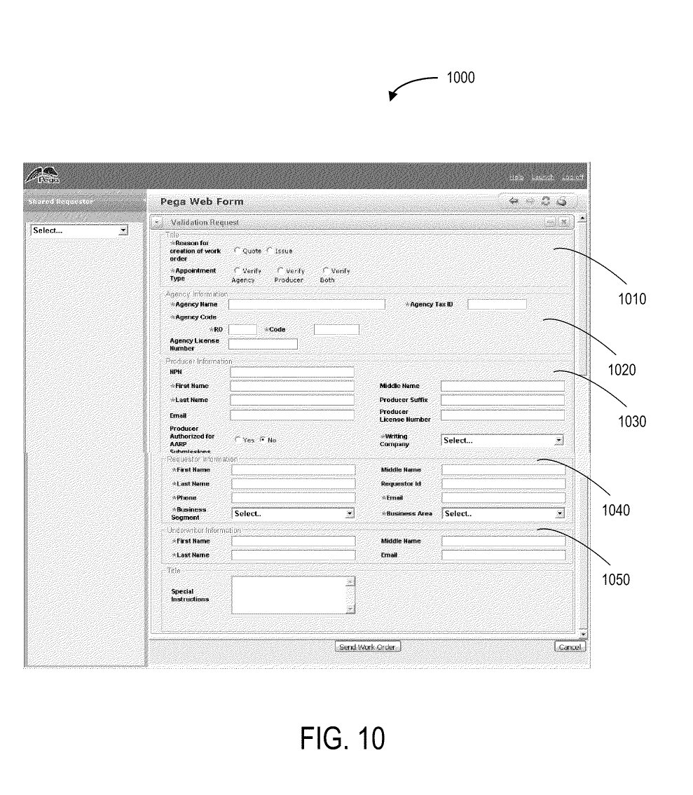

FIG. 10 is an example of a display 1000 according to some embodiments. The display 1000 might include an area 1010 to indicate a reason for the creation of a work order and/or the type of appointment associated with the work order. The display 1000 may also include an area 1020 to indicate agency information, such as a name and license number associated with the agency. Similarly, the display 1000 also includes an area 1030 to indicate information about the producer, including the producer's identification number (NPN), name, and license number. The display 1000 may further include an area 1040 to indicate information about the requestor, including a name, identifier, and associated business segment. Finally, the display 1000 might include an area 1050 to indicate information about the associated underwriter (e.g., a name and email address).

As a result of the embodiments described herein, the cost of carrying un-needed appointments may be reduced. Moreover, needed insurance appointments may be automatically identified and obtained in a timely fashion.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and engines described herein may be split, combined, and/or handled by external systems).

Applicants have discovered that embodiments described herein may be particularly useful in connection with property and casualty insurance appointments, although embodiments may be used in connection other types of insurance (e.g., life insurance). Moreover, although some embodiments have been described with respect to multi-state appointments, note that embodiments might be useful in other regulatory situations (e.g., a federal appointment process).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An automated appointment processing system, comprising:
a communication device to receive a plurality of new work notifications, each associated with a producer identifier;
a processor coupled to the communication device; and
a storage device in communication with said processor and storing instructions adapted to be executed by said processor to:
determine a set of non-appointed new work notifications, including a first non-appointed new work notification and a second non-appointed new work notification, the second non-appointed new work notification being received after the first non-appointed new work notification,
automatically prioritize at least some of the non-appointed new work notifications such that the second new work notification is assigned a higher priority as compared to the first new work notification, and
arrange for a manual appointment processing procedure to be performed for at least some of the non-appointed new work notifications in accordance with said prioritizing.

2. The system of claim 1, wherein the a storage device further stores instructions adapted to be executed by said processor to identify at least one non-appointed new work notification as satisfying a pre-determined condition and to generate, in response to said identification, an exception handling event.

3. The system of claim 2, wherein the exception handling event indicates that the non-appointed work notification requires manual appointment processing.

4. The system of claim 1, wherein new work notifications are associated with property and casualty insurance policies.

5. The system of claim 1, wherein different new work notifications are associated with different governmental departments, each governmental department having an associated compliance time requirement, and the automatic prioritization is based at least in part on compliance time requirements.

6. The system of claim 1, wherein a determination of a non-appointed new work notification is associated with at least one of: (i) a non-appointed producer, or (ii) a non-appointed agency.

7. The system of claim 1, wherein a new work notification includes at least one of: (i) a producer name, (ii) a national producer number, or (iii) a selection from a producer reference list.

8. The system of claim 1, wherein the a storage device further stores instructions adapted to be executed by said processor to generate a report associated with a batch of new work notifications.

9. The system of claim 1, wherein the processor is associated with at least one of: (i) an enterprise data warehouse, (ii) a business process management engine, or (iii) a database/workflow engine.

10. A computer-implemented method to facilitate automated insurance appointment processing, comprising:
receiving a plurality of new work notifications, each associated with a producer identifier;
determining a set of non-appointed new work notifications, including a first non-appointed new work notification and a second non-appointed new work notification, the second non-appointed new work notification being received after the first non-appointed new work notification;
automatically identifying at least one non-appointed new work notification as satisfying a pre-determined condition and generating, in response to said identification, an exception handling event that indicates that the non-appointed work notification requires manual appointment processing;
automatically prioritizing the identified non-appointed new work notifications such that the second new work notification is assigned a higher priority as compared to the first new work notification
storing prioritization results in a database in connection with the identified non-appointed new work notifications; and
arranging for the manual appointment processing to be performed for at least some of the non-appointed new work notifications in accordance with said prioritizing.

11. The method of claim 10, wherein new work notifications are associated with property and casualty insurance policies.

12. The method of claim 10, wherein different new work notifications are associated with different governmental departments, each governmental department having an associated compliance time requirement, and the automatic prioritization is based at least in part on compliance time requirements.

13. The method of claim 10, wherein a determination of a non-appointed new work notification is associated with at least one of: (i) a non-appointed producer, or (ii) a non-appointed agency.

14. The method of claim 10, wherein a new work notification includes at least one of: (i) a producer name, (ii) a national producer number, or (iii) a selection from a producer reference list.

15. A system, comprising:
a electronic data warehouse device to receive a plurality of new work records, each associated with a producer identifier, including a first record received before a second record;
a business process management device to determine a set of non-appointed new work records, and to automatically prioritize at least some of the non-appointed new work records that require manual processing such that the first new work record is assigned a lower priority as compared to the second new work record,
an interface to a third party service to automatically appoint new work records that do not require manual processing, and
an output device to provide an ordered list of the non-appointed new work records requiring manual processing in accordance with said prioritizing.

16. The system of claim 15, wherein new work records are associated with property and casualty insurance policies.

17. The system of claim 15, wherein different new work records are associated with different governmental departments, each governmental department having an associated compliance time requirement, and the automatic prioritization is based at least in part on compliance time requirements.

18. The system of claim 15, wherein a determination of a non-appointed new work record is associated with at least one of: (i) a non-appointed producer, or (ii) a non-appointed agency.

19. The system of claim 15, wherein a new work record includes at least one of: (i) a producer name, (ii) a national producer number, or (iii) a selection from a producer reference list.

20. The system of claim 15, wherein a set of pre-appoint processing conditions may be automatically reviewed to determine that the conditions have been satisfied prior to executing the automatically appointment of new work records.

21. The system of claim 15, wherein one of the pre-appoint processing conditions is associated with an indication representing that a background investigation consent form in on file.
